(19) United States
(12) Patent Application Publication
(10) Pub. No.: US 2024/0177083 A1
(43) Pub. Date: May 30, 2024

(54) MATCHING TASKS AND SERVICE PROVIDERS WITHOUT POLLING

(71) Applicant: Zendesk, Inc., San Francisco, CA (US)

(72) Inventors: Ciarán Archer, Dublin (IE); Chaminda Peiris, Arklow (IE); Nguyen Anh Tuan, Singapore (SG); Fernando Rincon Martin, Singapore (SG); Khoa Dang Bui, Dublin (IE); John Clifford, Dublin (IE)

(73) Assignee: Zendesk, Inc., San Francisco, CA (US)

(21) Appl. No.: 18/059,918

(22) Filed: Nov. 29, 2022

(51) Int. Cl. G06Q 10/0631

(52) U.S. Cl. CPC G06Q 10/063112

(57) ABSTRACT

A system and methods are provided for matching electronic tasks with actors able to process and complete the tasks, without polling. When a new task is received and no qualified actor is available, instead of repeatedly polling or querying actors, a task event is emitted that describes the task by criteria that can be used to match the task to a qualified actor. Similarly, when an actor becomes available and no suitable task is pending, instead of repeatedly polling or querying pending tasks, a corresponding actor event is emitted. Consumers of the events therefore attempt to match a pending task and an available actor only when there is a change to the tasks and/or the available actors.

### BACKGROUND

This disclosure relates to the field of computer systems. More particularly, a system and methods are provided for matching electronic tasks with actors without polling either type of entity (i.e., tasks or actors).

In many computing environments, tasks continually arrive that must be assigned to actors that can perform the necessary processing. For example, when a new data event (e.g., a help request, a change to a data value, creation of a new data record) is received, it must be routed to a suitable automated or human actor as soon as possible. Some actors may only be able to process certain types of tasks, which can complicate the routing process.

In traditional computing systems and environments, routing logic receives or learns of a new task, or a change to an existing task, and determines whether a suitable actor is available to service the task. Typically, the system begins a process of polling actors to determine whether a suitable actor is or has become available. Significant levels of computing resources may be monopolized as the system frequently polls all actors. Because there may be no change to the actors' availabilities between successive polling operations, the resources are consumed with no corresponding benefit.

Similarly, when a new actor comes online or an existing actor can accept another task (e.g., after finishing a current task), a traditional system will begin a process of continually or frequently polling to find a task to assign to the newly available actor. Again, the system may consume significant computing resources while attempting to match a task with an actor, even if there is no change to the configurations or statuses of the tasks and/or actors since the previous polling operation.

### SUMMARY

In some embodiments, systems and methods are provided for matching electronic tasks with actors (e.g., human agents, automated bots) without polling. In these embodiments, arrivals of new tasks, changes to existing tasks, and changes to actors' availabilities spawn events that cause the consumer(s) of the event to search available actors for one qualified to process the new or changed task or search pending tasks for one that the newly available actor is qualified to process.

In these embodiments, instead of polling, whenever a match is not immediately available for a new (or changed) task or a newly available actor, the system effectively pauses. The system does not attempt to make another match until an event arrives that signals receipt of another new/changed task or availability of an actor. Waiting/pending tasks and/or available actors may be prioritized for the purpose of matching them or, if multiple matches are found for a new task or newly available actor, one of them may be chosen based on any suitable criteria.

The system may include a task manager for receiving and storing tasks and emitting task events, and an actor manager for tracking actors' availabilities, storing their statuses, and emitting actor events. The system may also include a routing engine for consuming new events, recording them, and matching new events of one kind (e.g., task, actor) with the other. Any or all of these system components may be updated when a match is made and the matched task is assigned to and routed to the matched actor.

### DESCRIPTION OF THE FIGURES

FIG. 1 is a block diagram depicting a computing environment in which tasks and actors are matched without polling, in accordance with some embodiments.

FIG. 2 is a flow chart illustrating a method of matching tasks and actors without polling, in accordance with some embodiments.

### DETAILED DESCRIPTION

The following description is presented to enable any person skilled in the art to make and use the disclosed embodiments, and is provided in the context of one or more particular applications and their requirements. Various modifications to the disclosed embodiments will be readily apparent to those skilled in the art, and the general principles defined herein may be applied to other embodiments and applications without departing from the scope of those that are disclosed. Thus, the present invention or inventions are not intended to be limited to the embodiments shown, but rather are to be accorded the widest scope consistent with the disclosure.

In some embodiments, electronic tasks received at a data center or other computing environment are matched with actors capable of servicing the tasks, without regular polling of tasks or actors. In these embodiments, corresponding events are emitted via a real-time event streaming framework (e.g., Apache Kafka®) when new (or changed) tasks are received and when actors become available to accept new tasks. Thus, instead of regularly polling either type of entity and wasting significant computing resources (e.g., processor cycles, memory, storage, communication bandwidth) when no match can be made between a task and an actor, events are monitored and consumed to only attempt matches when there is a high likelihood of success.

Tasks that await assignment to actors, and actors awaiting assignment of new tasks, are queued or otherwise recorded. As events representing availability of tasks and actors are observed, matches can be made as appropriate. Not all tasks may be suitable for all actors, and not all actors may be able to process all tasks.

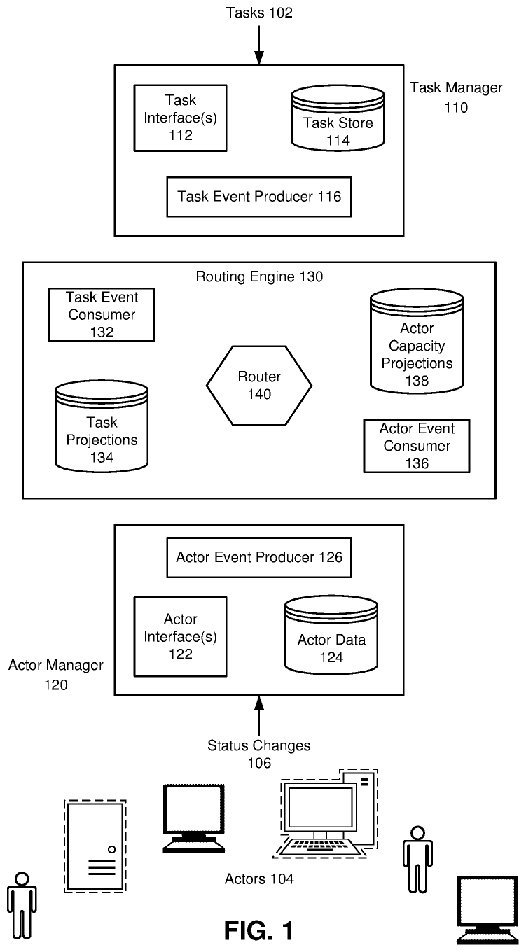

FIG. 1 is a block diagram of a computing environment in which tasks and actors are matched without regular polling, according to some embodiments. In these embodiments, tasks 102 include telephone calls, instant messages, electronic mail messages, customer support tickets, and/or other electronic communications such as inquiries submitted via an application. Tasks 102, which may include new tasks and/or changes to tasks that have not yet been completed, are received by task manager 110. In some embodiments, tasks are generated by end users that are seeking information or assistance regarding a product or a service offered by an organization (e.g., a business, a governmental agency, a nonprofit), and may be routed or received by a customer service platform, help desk, or data center that supports the organization.

Actors 104 comprise human agents (e.g., customer support agents), organizations, bots, and/or other computerized processes for handling tasks 102. Status changes 106 reflect changes in availability of actors 104 (e.g., a new actor comes online or becomes available, an existing actor finishes another task) and are received by actor manager 120.

Task manager 110 includes one or more task interfaces 112, one or more task stores 114, and task event producer 116. Task manager 110 and/or components of the task manager may execute on any number of physical and/or virtual computer systems, which may be distributed and may be operated by one or more organizations. Task interfaces 112 include interfaces for receiving tasks (e.g., from end users, from computer systems operated by end users), for assigning tasks to actors, and/or for other purposes. Task store 114 records tasks that have been received by task manager 110, their statuses and/or dispositions, and/or other information regarding tasks.

As tasks are assigned to actors, are processed, and completed, task store 114 may be updated accordingly, and tasks that have been resolved may be archived within or without the task manager. Task event producer 116 emits task events corresponding to new tasks 102 received by task manager 110. These events are submitted to an event processing system such as Apache Kafka.

Actor manager 120 includes one or more actor interfaces 122, actor data 124, and actor event producer 126. Actor manager 120 and/or components of the actor manager may execute on any number of physical and/or virtual computer systems, which may be distributed and may be operated by one or more organizations. Actor interfaces 122 include interfaces for receiving status changes 106 (e.g., from actors, from computer systems operated by actors), for assigning actors to tasks, and/or for other purposes. Actor data 124 stores data related to actors 104, such as their maximum capacities (e.g., maximum number of tasks they can handle concurrently), current capacities (e.g., how many tasks each actor can accept beyond those currently being handled), skills (e.g., languages, familiarity with particular applications and/or products), types or categories of tasks they can handle, and/or other data.

As actors' availabilities and/or other statuses change, actor data store 124 may be updated accordingly. A given actor may only be able to handle certain types or categories of tasks, such as those dealing with particular types of issues, those associated with particular applications or types of data, and so on. In particular, actors may be placed into ‘groups’ that identify types and/or categories of tasks they are qualified to process; different groups may or may not overlap. Actor event producer 126 emits actor events corresponding to new status changes 106 received by actor manager 120.

Routing engine 130 includes task event consumer 132, task projections 134, actor event consumer 136, actor capacity projections 138, and router 140. Routing engine 130 and/or components of the routing engine may execute on any number of physical and/or virtual computer systems, which may be distributed and may be operated by one or more organizations.

Task event consumer 132 and actor event consumer 136 receive new task events and actor events, respectively, via the event processing system or framework through which the events were submitted. Task events or representations of the associated tasks are recorded in task projections 134, while actor events or representations of corresponding changes in actors' availabilities are recorded in actor capacity projections 138. Router 140 also consumes the events, or is notified of them, and attempts to match tasks with actors.

In particular, when a new task event is consumed (e.g., and recorded in task projections 134), information such as a task identifier, type/category of the task, and required skills (i.e., skills required by an actor in order to handle the task) are retrieved, and router 140 attempts to find a qualified and available actor among actor capacity projections 138. The new task event may be recorded in task projections 134 before searching for an actor or after failing to match the task to an actor, including some or all of the information received with the event.

When a new actor event is consumed, which includes information such as actor identifier, actor skills, types/categories of tasks they are qualified to handle, and/or other data, router 140 attempts to find a matching task among task projections 134. The new actor event is recorded in actor capacity projections 138 before searching for a task or after failing to match the actor to a task, including some or all of the information received with the event.

However, when a new task is matched to an available actor, and when a newly available actor is matched to a pending task, router 140 notifies task manager 110 and actor manager 120 of the assignment of the task to the actor. The task and actor managers can then update their stored data and the task is routed to the actor for processing.

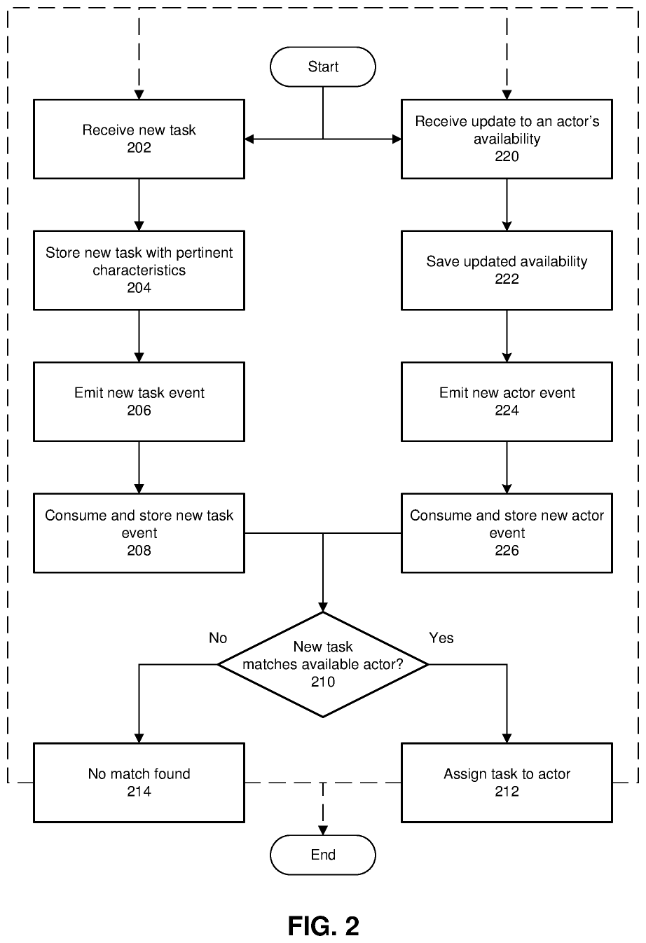

FIG. 2 is a flow chart of a method for matching an electronic task with an actor, without polling, according to some embodiments. One or more of the operations may be omitted, repeated, and/or performed in a different order. Accordingly, the specific arrangement of steps shown in FIG. 2 should not be construed in a manner that limits the scope of the embodiments.

In operation 202, a new task is received at a help desk, customer support system, data center, or other computing environment or system that regularly receives tasks for processing by actors. The system may comprise any number and type of computers, physical and/or virtual. For example, a data center may be operated by an organization to support one or more applications and/or services, and tasks may be regularly received from users, customers, the organization and/or other organizations. The task may take the form of a trouble ticket, an electronic mail message, an instant message, a custom communication generated by a supported application, a telephone call, or some other electronic communication.

In operation 204, the new task is stored (e.g., in task store 114 of FIG. 1). This may involve determining or assigning task characteristics such as priority, age (e.g., when the task was created or received), type (e.g., a customer support ticket, an electronic mail message, an instant message), category or topic (e.g., product support, sales, billing), skills required to process the task (e.g., language, knowledge of a particular application), an originator of the task (e.g., a user, a customer), etc.

In operation 206, the system (e.g., task manager 110 of FIG. 1) emits a new task event via an event streaming framework (e.g., Apache Kafka®). The event may include an identifier of the task and any or all other characteristics or criteria of the task.

In some embodiments, a change to a task (particularly a task not yet assigned to an actor) may be treated as a new task. Thus, if different actors can (or must) now handle the task due to the change, it may be considered a new task and cause emission of a new task event. For example, a change to an existing task's category may mean that only actors in a group different from a group of actors associated with the task's previous category can or should now process the task.

In some other embodiments, when a new task is received, an attempt may first be made to find a qualified available actor, and an event may be emitted only if this attempt fails.

In operation 208, the new task event is consumed (e.g., by task event consumer 132 of routing engine 130 of FIG. 1). Consumption of the task event may include storing a representation or profile of the new task in a repository (e.g., task projections 134 of FIG. 1), which will help the routing engine match the task to an actor.

In operation 210, a router or other system component configured to match tasks and actors learns or is notified of the new event and, based on the nature of the event (e.g., a new task, an actor status change), searches for a match. Thus, for a new task event, the router may query actor capacity projections 138 of FIG. 1, and for a new actor event may query task projections 134. Based on details of the new event (e.g., category and type of a new task, group and skills of an actor who is now available), the corresponding data store is searched for one or more matches.

In operation 212, a match is found, meaning that a new or pending task is matched with an actor that can immediately accept and process the task. If multiple matches are found (e.g., multiple actors that can accept a given task, multiple tasks suitable for an available actor), a ‘best’ match is selected based on the priority or age of a task, skills of an actor, and/or other factors. The new task is routed to the available actor and data stores are updated as necessary to reflect the assignment. For example, a task store may be updated to indicate that the task has been assigned to the actor, while an actor data store may be updated to indicate the actor's new (decreased) availability resulting from the new assignment.

In some implementations in which an actor event indicates a given actor has capacity to receive multiple new tasks, operation 212 may be performed multiple times in succession for the one event, until the actor no longer is available to accept a new task. Alternatively, the query may return multiple matching tasks and some or all of them may be assigned to the actor simultaneously or in succession. In other words, a given actor event may result in one or more tasks being assigned to a newly available actor.

In operation 214, however, no match is found. Thus, if the event relates to a new task, the task cannot be assigned until a qualified actor becomes available, at which time a corresponding new actor event is emitted and consumed, thereby triggering a new match attempt. Similarly, if the event relates to availability of an actor, no matching tasks exist and the actor's availability cannot be filled until a new task is received that the actor is qualified to process. After operation 214, the method may return to operation 202 to accept a new task, proceed to operation 220 to accept an actor status change, or end.

In operation 220, the system learns that an actor has become available to receive at least one unassigned task. For example, the actor may have just come online or may have finished processing a previous task. In some embodiments, actors maintain statuses with the system so that the system learns when their statuses change (e.g., start or end a work shift, take a break, return from a break, complete a task, receive a task). Thus, the system may keep track of how many tasks each actor is handling and/or keep track of how many additional tasks (i.e., zero or more) the actor can accept.

In operation 222, the actor's updated status is saved (e.g., in actor data 124 of FIG. 1).

In operation 224, the system (e.g., actor manager 120 of FIG. 1) emits a new task event via the event streaming framework. The event may include an identifier of the actor, its group, skills, how many new/additional tasks it can accept, etc. The actor's group may identify the categories and/or types of tasks the actor can process, and the actor's skills may reveal languages and/or other talents or qualifications. The event may also identify the type of actor (e.g., a human agent, a bot or artificial intelligence model).

In some embodiments, when notification of availability of an actor is received, an attempt may first be made to find a waiting/pending task that the actor is qualified to process, and an event may be emitted only if this attempt fails.

In operation 226, the new actor event is consumed (e.g., by actor event consumer 136 of routing engine 130 of FIG. 1). Consumption of the actor event may include recording a representation or profile of the change in the actor's current availability in a repository (e.g., actor capacity projections 138 of FIG. 1), which will help the routing engine match the actor to a waiting task. After operation 226, the method proceeds to operation 210, returns to operation 220, or ends.

In some embodiments, incoming (new) tasks are assigned to queues (e.g., within task manager 110 of FIG. 1) to help ensure they are serviced by appropriate actors and with appropriate priorities. In particular, task queues are akin to properties and do not involve actual queue data structures. For example, task queues may have associated priorities, categories or groups that identify which actors (e.g., which groups of actors) can process tasks placed in the queues, and/or other characteristics.

Each incoming task resides in only one queue at a time, based on application of queue rulesets, but may transition between queues. For example, each queue may have an associated ruleset that operates upon tags associated with a task in order to determine whether a given task should be added to the queue. For a new incoming task, application of multiple queues' rulesets may proceed in order of the queues' priorities. A default queue may accept all tasks that don't match any other queues' rulesets.

An environment in which one or more embodiments described above are executed may incorporate a general-purpose computer or a special-purpose device such as a hand-held computer or communication device. Some details of such devices (e.g., processor, memory, data storage, display) may be omitted for the sake of clarity. A component such as a processor or memory to which one or more tasks or functions are attributed may be a general component temporarily configured to perform the specified task or function, or may be a specific component manufactured to perform the task or function. The term “processor” as used herein refers to one or more electronic circuits, devices, chips, processing cores and/or other components configured to process data and/or computer program code.

Data structures and program code described in this detailed description are typically stored on a non-transitory computer-readable storage medium, which may be any device or medium that can store code and/or data for use by a computer system. Non-transitory computer-readable storage media include, but are not limited to, volatile memory; non-volatile memory; electrical, magnetic, and optical storage devices such as disk drives, magnetic tape, CDs (compact discs) and DVDs (digital versatile discs or digital video discs), solid-state drives, and/or other non-transitory computer-readable media now known or later developed.

Methods and processes described in the detailed description can be embodied as code and/or data, which may be stored in a non-transitory computer-readable storage medium as described above. When a processor or computer system reads and executes the code and manipulates the data stored on the medium, the processor or computer system performs the methods and processes embodied as code and data structures and stored within the medium.

Furthermore, the methods and processes may be programmed into hardware modules such as, but not limited to, application-specific integrated circuit (ASIC) chips, field-programmable gate arrays (FPGAs), and other programmable-logic devices now known or hereafter developed. When such a hardware module is activated, it performs the methods and processes included within the module.

The foregoing embodiments have been presented for purposes of illustration and description only. They are not intended to be exhaustive or to limit this disclosure to the forms disclosed. Accordingly, many modifications and variations will be apparent to practitioners skilled in the art. The scope is defined by the appended claims, not the preceding disclosure.

What is claimed is:

1. A method of matching electronic tasks to actors able to process the tasks, the method comprising:
receiving a new task;
emitting a corresponding task event describing the new task; and
attempting to match the new task with a qualified actor, without polling.

2. The method of claim 1, wherein attempting to match the new task with a qualified actor without polling comprises:
consuming the corresponding task event; and
based on the description of the new task, querying an actor availability repository to identify an available actor qualified to process the new task.

3. The method of claim 2, further comprising:
when the query returns an available qualified actor, assigning the new task to the available qualified actor; and
when the query is unsuccessful, refraining from polling actors' availabilities.

4. The method of claim 2, wherein consuming the corresponding task event comprises recording the task event in a task repository.

5. The method of claim 2, wherein refraining from polling actors' availabilities comprises waiting for an actor event that signals new availability of an actor.

6. The method of claim 1, further comprising:
receiving an availability update reflecting a change in an associated actor's availability;
emitting a corresponding actor event describing the associated actor's availability; and
attempting to match the associated actor with a task that the associated actor is qualified to process, without polling.

7. The method of claim 6, wherein attempting to match the associated actor with a task that the associated actor is qualified to process comprises:
consuming the corresponding actor event; and
based on the associated actor, querying a task repository to identify a task the associated actor is qualified to process.

8. The method of claim 7, further comprising:
when the query returns a task the associated actor is qualified to process, assigning the pending task to the associated actor; and
when the query is unsuccessful, refraining from polling for new tasks.

9. The method of claim 7, wherein consuming the corresponding actor event comprises recording the actor event in an actor availability repository.

10. The method of claim 7, wherein refraining from polling for new tasks comprises waiting for a task event that signals receipt of another new task.

11. A non-transitory computer-readable medium storing instructions that, when executed by a processor, cause the processor to perform a method of method of matching electronic tasks to actors able to process the tasks, the method comprising:
receiving a new task;
emitting a corresponding task event describing the new task; and
attempting to match the new task with a qualified actor, without polling.

12. The non-transitory computer-readable medium of claim 11, wherein attempting to match the new task with a qualified actor without polling comprises:
consuming the corresponding task event; and
based on the description of the new task, querying an actor availability repository to identify an available actor qualified to process the new task.

13. The non-transitory computer-readable medium of claim 12, wherein the method further comprises:
when the query returns an available qualified actor, assigning the new task to the available qualified actor; and
when the query is unsuccessful, refraining from polling actors' availabilities and waiting for an actor event that signals new availability of an actor.

14. The non-transitory computer-readable medium of claim 11, wherein the method further comprises:
receiving an availability update reflecting a change in an associated actor's availability;
emitting a corresponding actor event describing the associated actor's availability; and
attempting to match the associated actor with a task that the associated actor is qualified to process, without polling.

15. The non-transitory computer-readable medium of claim 14, wherein attempting to match the associated actor with a task that the associated actor is qualified to process comprises:
consuming the corresponding actor event; and
based on the associated actor, querying a task repository to identify a task the associated actor is qualified to process.

16. The non-transitory computer-readable medium of claim 15, further comprising:
when the query returns a task the associated actor is qualified to process, assigning the pending task to the associated actor; and
when the query is unsuccessful, refraining from polling for new tasks and waiting for a task event that signals receipt of another new task.

17. A system for matching electronic tasks to actors able to process the tasks, comprising:
one or more processors; and
memory storing instructions that, when executed by the one or more processors, cause the system to:
receive a new task;
emit a corresponding task event describing the new task; and
attempt to match the new task with a qualified actor, without polling.

18. The system of claim 17, wherein attempting to match the new task with a qualified actor without polling comprises:
consuming the corresponding task event; and
based on the description of the new task, querying an actor availability repository to identify an available actor qualified to process the new task.

19. The system of claim 18, further comprising:
when the query returns an available qualified actor, assigning the new task to the available qualified actor; and
when the query is unsuccessful, refraining from polling actors' availabilities.

20. The system of claim 19, wherein refraining from polling actors' availabilities comprises waiting for an actor event that signals new availability of an actor.

21. The system of claim 17, further comprising:
receiving an availability update reflecting a change in an associated actor's availability;
emitting a corresponding actor event describing the associated actor's availability; and
attempting to match the associated actor with a task that the associated actor is qualified to process, without polling.

22. The system of claim 21, wherein attempting to match the associated actor with a task that the associated actor is qualified to process comprises:
consuming the corresponding actor event; and
based on the associated actor, querying a task repository to identify a task the associated actor is qualified to process.

23. The system of claim 22, further comprising:
when the query returns a task the associated actor is qualified to process, assigning the pending task to the associated actor; and
when the query is unsuccessful, refraining from polling for new tasks.

24. The system of claim 23, wherein refraining from polling for new tasks comprises waiting for a task event that signals receipt of another new task.
